(19) United States
(12) Patent Application Publication
(10) Pub. No.: US 2005/0035969 A1
(43) Pub. Date: Feb. 17, 2005

(54) Method for representation of teletext pages on a display device

(76) Inventors: Guenter Hoeck, Bichl (DE); Michael Abler, Muenchen (DE); Thomas Bartholomae, Muenchen (DE); Manfred Mauser, Egling (DE)

Correspondence Address: Gauthier & Connors LLP, Suite 3300, 225 Franklin Street, Boston, MA, 02110, US

(21) Appl. No.: 10/885,500

(22) Filed: Jul. 6, 2004

(30) Foreign Application Priority Data
Jul. 4, 2003 (DE) 103 30 329.4-53

(51) Int. Cl. G06T 11/00

(52) U.S. Cl. 345/467

(57) ABSTRACT

The present invention relates to a method for representation of teletext information in an image of a display device constructed pixel by pixel, wherein the method comprises the following steps: furnishing a teletext signal comprising a sequence of teletext characters, selecting a character from a character set, comprising a matrix of pixels, associated with each encoded teletext character, representing the selected character pixel by pixel on the display device, wherein a first and a second character set is furnished and the characters associated with the encoded teletext characters are selected from the first or second character depending on whether teletext pages are to be represented one above the other in the vertical direction on the display device.

The present invention relates to a method for representation of teletext pages on a display device.

Television receivers and videorecorders available today contain teletext processing units, which are used to separate teletext signals, transmitted in the video blanking interval (VBI) of a so-called color picture signal (FBAS), from said FBAS signal and deposit the teletext information page by page in a memory, while such memories can be configured to store up to several hundred teletext pages, which can be presented at will on a monitor screen.

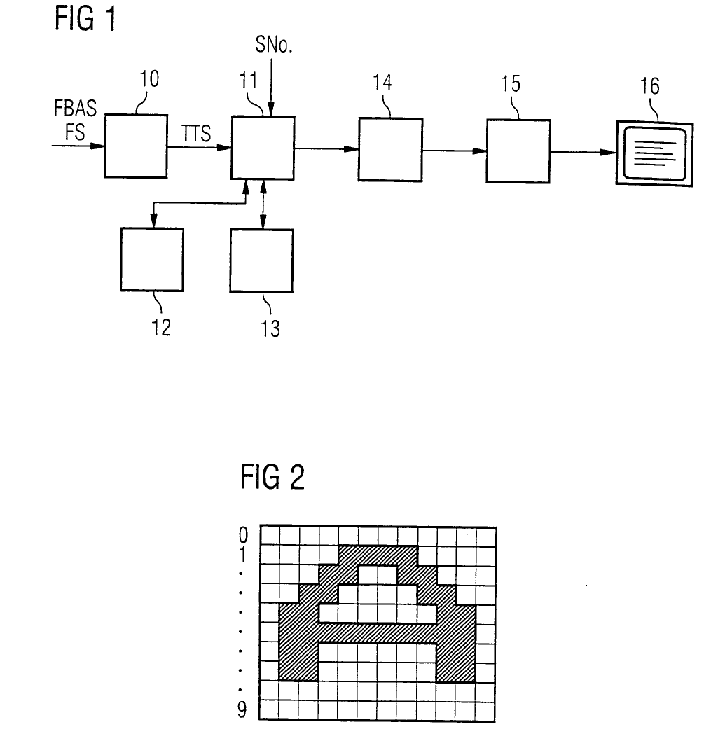

FIG. 1 is a schematic block diagram of a traditional teletext processing unit, which has a separation stage 10 for separating the teletext signal from the FBAS signal, and a decoder 11, connected to the separation stage, being coordinated with a page memory 12 for storing the received and decoded teletext pages.

Teletext data is usually transmitted at a data rate of 6.9375 MHz, 7 data bits and one parity bit being transmitted for each character of a page. Such a binary data sequence, which represents a character being depicted, such as a letter of the alphabet, is designated hereinafter as an encoded character. The teletext data are placed in the memory in the form of such encoded characters.

One line of a teletext row can usually represent 40 characters. This corresponds to a data volume of 320 bits per row. One teletext page usually contains 25 rows, which are numbered from 0 to 24, row 0 being used as the headline, rows 1 to 23 contain the text information transmitted by the transmitter, and row 24 contains supplemental control information, such as FLOF (Full Level One Features) information, or FLOF information for page navigation, provided this is supported by the transmitter.

The individual characters of a teletext page are represented on the monitor screen as a matrix of pixels, while in present-day teletext presentations for each character there is represented a pixel matrix with 12×10 pixels, i.e., with 10 pixel lines and 12 pixel columns. Each pixel is characterized by RGB pixel information. In order to represent a teletext page, a pixel matrix representing the particular character is assigned to each binary encoded character stored on a page and the resulting sequence of individual pixel matrices is deposited, pixel by pixel, in a memory 14 connected to the decoder, which can be read out by a device 15 controlling the monitor screen 16, in order to represent the individual characters on the screen 16.

In FIG. 1, the reference number 13 designates such a character memory, in which the pixel information assigned to the individual representable characters is saved. FIG. 2 illustrates, as an example, the pixel matrix with 12×10 pixels assigned to the representable character “A,” where for reasons of simpler representation only the color information black or white is assigned to the individual pixels in the example, rather than RGB information.

Traditional television images are transmitted as a sequence of line-interlaced fields and are represented on the monitor screen as fields, while one field in the PAL TV standard comprises 312.5 image lines, 280 of which are visible, so that for characters constructed from 10 pixel lines in theory one can represent 28 teletext lines on the screen. Apart from this, individual television sets or television receivers can of course have interpolation devices, which are designed to produce a sequence of frames from a sequence of fields, i.e., also from a sequence of fields comprising teletext information.

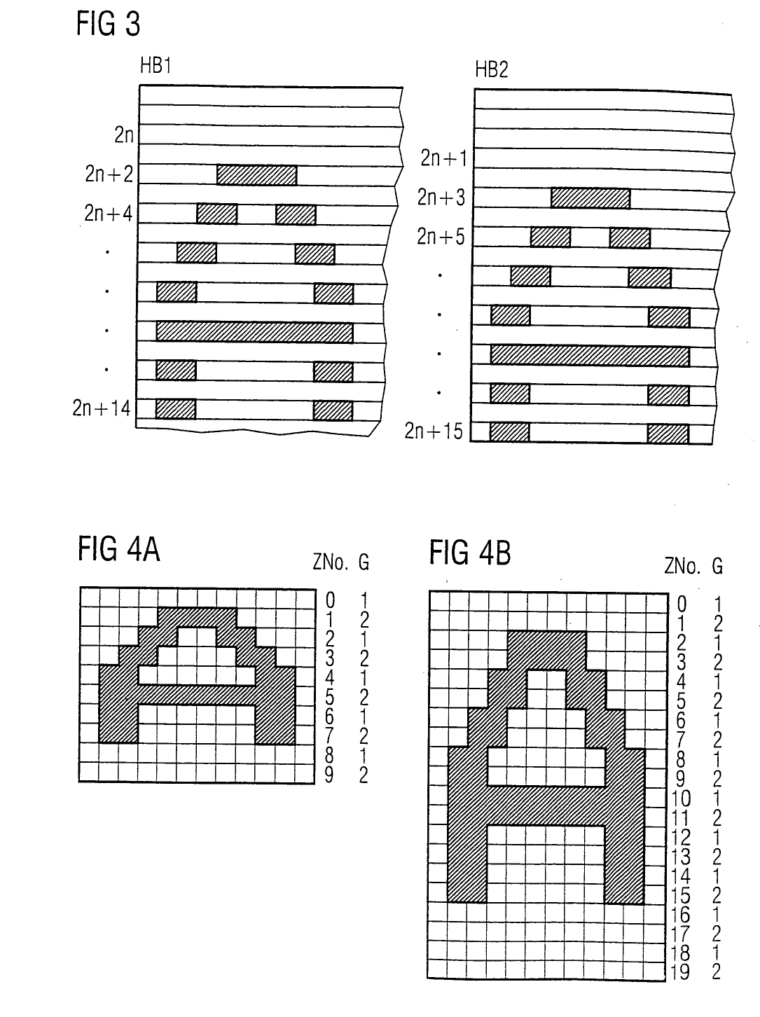

In conventional methods for representation of teletext information, the same pixel information is represented in one even-numbered line of a field and in the odd-numbered line of the following field coordinated with the even-numbered line. In other words: two consecutive fields differ only in screen position, but otherwise contain identical information. This is shown schematically in FIG. 3 for the depiction of the character “A,” where the field HB1 in the figure comprises the even-numbered lines and the following field HB2, the odd-numbered lines of the image. Here, the content of one line 2n+i of the field HB1 corresponds to the content of the line 2n+i+1 of the field HB2, where n is a whole number.

EP 0 561 028 B1 describes a method for representation of two teletext pages next to each other in the horizontal direction on a monitor screen, which method provides for increasing the pixel frequency during the representation of teletext pages.

The goal of the present invention is to provide a method for representing at least two teletext pages in the vertical direction on a display device or a monitor screen, one above the other.

This goal is accomplished by a method according to the features of Claim 1. Advantageous embodiments of the method are the subjects of the subsidiary claims.

In the method according to the invention for representation of teletext information of a first and second teletext page, one above the other in the vertical direction in an image constructed pixel by pixel on a display device, it is proposed to furnish a teletext signal that comprises a sequence of encoded teletext characters, and to furnish a first character set with a number of characters, each of them constructed from a matrix with m×n pixels. From this character set, one character is selected for each encoded character and the selected characters are represented pixel by pixel on the display device, wherein pixel information from first lines of the pixel matrix of the character is presented in the even-numbered lines of the image for representing a character on the display device and pixel information from second lines of the pixel matrix of the character is presented in the odd-numbered lines of the image.

The first lines of the pixel matrix of a character correspond to the even-numbered lines and the second lines of the pixel matrix correspond to the odd-numbered lines, or vice versa.

This assignment of the first lines of the pixel matrix of a character to the even-numbered lines of the image being depicted and of the second lines of the pixel matrix to the odd-numbered lines of the image is independent of whether the image presentation occurs in the so-called interlaced mode or in the so-called progressive mode. In the interlaced mode, a sequence of fields is produced for the presentation on the display device, wherein even-numbered lines and odd-numbered lines of the image are alternately written to produce the individual consecutive fields. In the progressive mode, a sequence of frames is produced for the presentation on the display device, wherein both even-numbered lines and odd-numbered lines of the image are written to produce the individual consecutive frames.

In the method according to the invention, the resolution in the vertical direction of the image can be doubled compared to the traditional method, so that when using a traditional character set, comprising characters with 12×10 pixels, one only requires 140 field lines or 280 frame lines to represent 28 teletext lines, which can represent two teletext pages, one above the other.

To implement the method, one preferably uses a line-organized memory, in which the video information of the individual pixels of the selected characters forming the first and second teletext page are saved and read out to present the characters on the display device. The number of pixels saved in the memory will correspond to the number of pixels being represented on the monitor screen, so that the memory represents a “mapping” of the display device.

In one embodiment of the invention, the video information for four teletext pages is represented on one monitor screen page, namely two teletext pages one above the other and two teletext pages next to each other in the horizontal direction. This produces a four-quadrant representation, in which one teletext page is represented in each of the four quadrants of the image on the display device.

A line-organized memory is also preferably used to implement this method, being chosen so that the video information of four teletext pages can be memorized, each of them built up from characters of the first character set. This memory is read out at such a frequency that, during a period of time in which one line of the image being represented is constructed, the video information is read out from every image line of two teletext pages being represented next to each other on the monitor screen.

In another embodiment of the method, a single third teletext page is represented in the horizontal direction of the image next to the first and second vertically juxtaposed teletext pages. This method calls for a second character set with a number of characters, each of which is constructed from a matrix of i×j pixels, and one character from this set is selected for each encoded teletext character of the third teletext page. For the representation of a character of the third teletext page on the display device in this case, pixel information from first lines of the pixel matrix of the character is presented in the even-numbered lines of the image, and pixel information from second lines of the pixel matrix of the character is presented in the odd-numbered lines of the image.

Also, in this case, the first lines of the pixel matrix are preferably the even-numbered lines, and the second lines are the odd-numbered lines, or vice versa.

In a exemplary embodiment, we have m=i and n=2·j, so that the individual characters of the first and second set comprise just as many pixel columns, yet differ by a factor of two as regards the number of pixel lines. Given a first character set with characters comprising 12×10 pixels, the characters of the second character set will then comprise 12×20 pixels.

In this exemplary embodiment, 10 pixel lines are required to represent one row of the first or second teletext page, while 20 pixel lines are required to represent one row of the third teletext page, so that the first and second teletext page can be represented one above the other in the vertical direction and a third teletext page can be represented next to them, while the third teletext page takes up the same space in the vertical direction on the resulting image as the first and second teletext page together.

In the example, where m=i and n=2·j, especially m=i=12 and n=20 or j=10, the characters of the second character set can be easily formed, for example, from already available characters of the first character set in that the pixel information of one line of a character of the first character set corresponds to the pixel information in two consecutive lines of the pixel matrix of a character of the second character set. The generating of this second character set with 12×20 pixels, for example, need be done only once, of course, and the character set can then be saved in memory.

The present invention will now be explained in greater detail with reference to figures:

FIG. 1 shows schematically, a block diagram of a teletext processing unit in the state of the art,

FIG. 2 is a pixel matrix constructed from 12×10 pixels to represent a teletext character, in the example the character “A,”

FIG. 3 is a schematic illustration of the representation of the character according to FIG. 2 in a sequence of fields with line-interlaced fields,

FIG. 4 is a sample representation of the pixel matrix of a character—in the example, the character “A”—of a first character set (FIG. 4a) and of a character—in the example, the character “A”—of a second character set (FIG. 4b) for use in the method according to the invention,

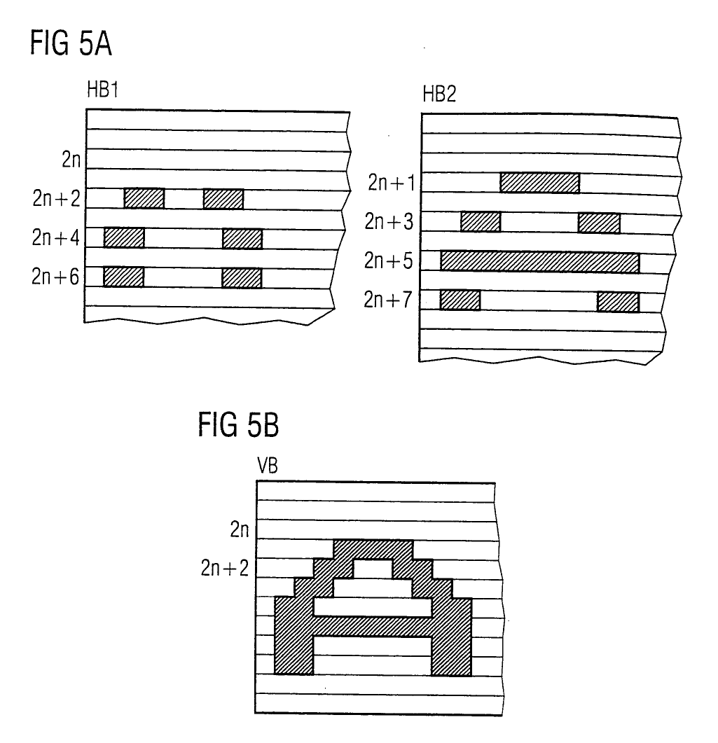

FIG. 5 illustrates the representation of a character of the first character set in a sequence of fields with line-interlaced fields (FIG. 5a) and in a sequence of frames (FIG. 5b),

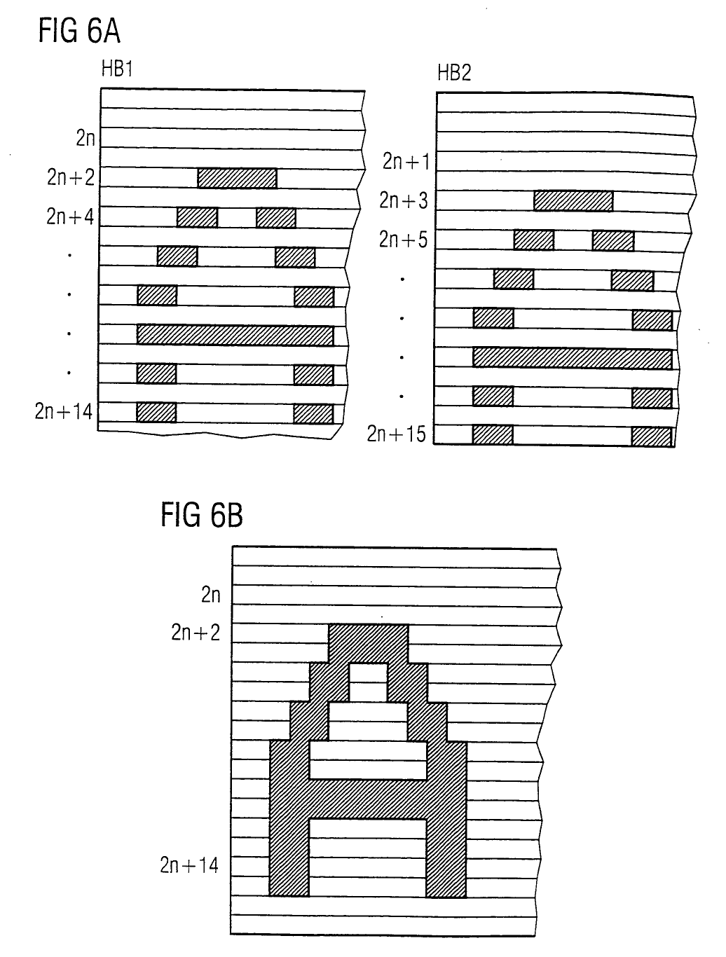

FIG. 6 illustrates the representation of a character of the second character set in a sequence of fields with line-interlaced fields (FIG. 6a) and in a sequence of frames (FIG. 6b),

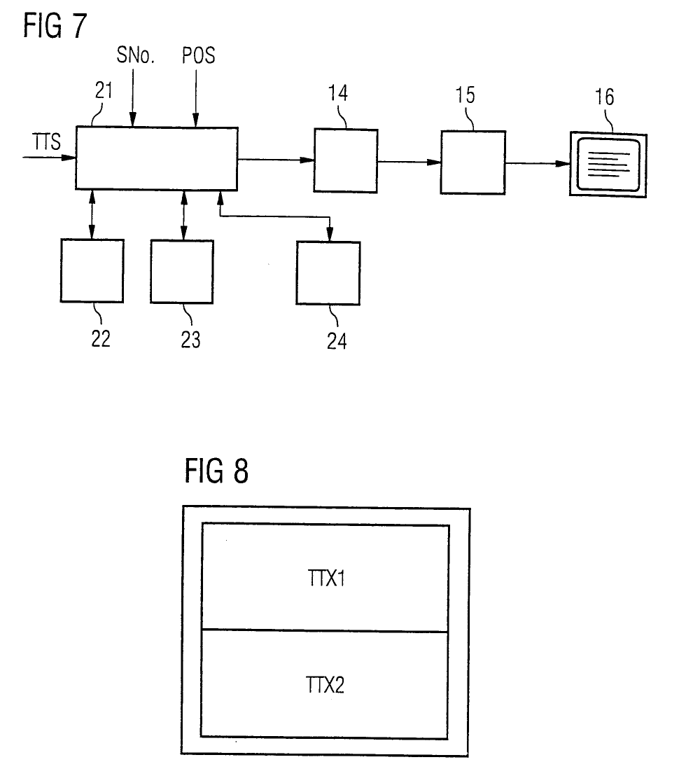

FIG. 7 is a schematic representation of a teletext processing device to implement the method according to the invention,

FIG. 8 is a schematic representation of an image comprising two teletext pages, one above the other in the vertical direction,

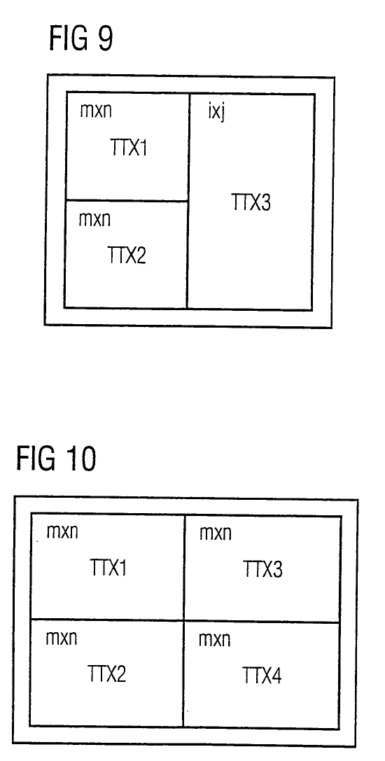

FIG. 9 is a schematic representation of an image, split in both the vertical and the horizontal direction, where two teletext pages are arranged one above the other and another teletext page is arranged neighboring the pages arranged one above the other,

FIG. 10 is a schematic representation of an image with two teletext pages arranged one above the other and one teletext page arranged next to the teletext pages arranged one above the other.

In the figures, unless otherwise indicated, the same reference numbers designate the identical parts and signals with identical meaning.

One important aspect of the present invention consists in providing a first character set, wherein the first character set comprises characters which consist of a pixel matrix with m×n pixels each. FIG. 4a shows, as an example, the pixel matrix of the teletext character “A” of the first character set, and this represented pixel matrix contains 12×10 pixels.

The teletext character shown in FIG. 4a and the following teletext characters yet to be discussed, presented in FIG. 4b, are of course only one example of the teletext characters of a set being represented, which comprise at least the upper-case letters of the alphabet and the most common punctuation signs.

Unlike the traditional method for representation of teletext characters in an image, in the method according to the invention one presents, in the even lines of the image constructed pixel by pixel or line or line, the pixel information of first lines, such as the even-numbered lines, and in the odd-numbered lines of the image, the pixel information of second lines, such as the odd-numbered lines, of the pixel matrix of the individual characters being represented, as is the case hereafter in FIG. 5 for the character of the first character set represented in FIG. 4a.

In the pixel matrix of FIG. 4a, ZNo designates the line number of the individual pixel lines of the character, and G indicates whether the individual lines are the first lines or second lines of the particular pixel matrix, while “1” stands for the first, even-numbered lines in the exemplary embodiment and “2” stands for the second, odd-numbered lines of the pixel matrix of the character in the exemplary embodiment.

In the exemplary embodiment, it is assumed that the even-numbered lines of the pixel matrix of a character are represented in even-numbered lines of the image, and the odd-numbered lines of the pixel matrix of a character are represented in the odd-numbered lines of an image. When representing a sequence of line-interlaced fields, in which only every second line is written per image, the result of this method is the representation presented in FIG. 5a of the character “A” presented in FIG. 4a, where HB1 designates the field in which video information is represented in the even-numbered lines, and HB2 designates the field in which video information is represented in the odd-numbered lines.

FIG. 5b shows the representation of the character according to FIG. 4a of the representation of a sequence of frames on the display device, i.e., when video information is represented in all the picture lines of the image.

The method according to the invention can double the resolution of the image in the vertical direction, so that two teletext pages can be represented one above the other in the vertical direction, as is shown in FIG. 8, wherein only 240 image lines are required for a teletext page with 24 teletext rows when using a first character set with m×n=12×10 pixels.

In order to implement this method of representation, for example, one can provide a line-organized memory, in which the video information is saved for the teletext characters selected to represent the teletext pages. The video information saved in the memory represents a mapping of the image being represented, and the memory is read out with a frequency adapted to the display device, at which the display device writes the individual lines of the image. In order to represent a sequence of fields on the display device, only every second “memory line” is read out, resulting in a representation of a single character according to the representation in FIG. 5a, and when the image frequency is high enough the individual parts of a character merge together into one character to the human eye. To present a sequence of frames, each memory line of the memory is read out for each image being presented, resulting in a representation of an individual character according to FIG. 5b.

As explained, the memory is read out adapted to the image repetition frequency of the display device, such as 50 Hz or 100 Hz. Of course, the memory only has to be updated a new teletext page is to be represented and first saved in the memory.

In a modification of the method according to the invention, four teletext pages are represented in one image, namely, one teletext page per quadrant, as is shown in FIG. 10. FIG. 10 shows schematically an image in which two teletext pages TTX1, TTX2 and TTX3, TTX4 are represented one above the other in the vertical direction and alongside each other in the horizontal direction. The individual teletext pages TTX1-TTX4 are each constructed row by row from characters of the first character set with m×n pixels, and here as well first lines of characters selected from the first character set are represented in first lines of the image and second lines of the matrix are represented in second lines of the image.

To implement such a method, a line-organized memory is preferably used, configured so as to save video information for four teletext pages, i.e., having twice the memory capacity of a memory needed to represent the image in FIG. 8. In this memory, the selected characters or the corresponding video information are deposited line by line according to their representation on the monitor screen. Assuming that one teletext row contains k characters, each of which consists of m×n pixels, video information on 2·k·m pixels is stored in one line of the memory, and the memory will read out according to the repetition frequency of the picture being shown so that one memory line will be read out during the time of writing of one image line of the picture being shown. The individual characters appear in the picture according to FIG. 10 compressed in the horizontal direction as compared to the individual characters in the picture according to FIG. 8, assuming that the dimensions of both pictures are the same.

The memory to be used for both the representation of the picture in FIG. 8 and for the representation of the picture in FIG. 9, each of which comprise two teletext pages represented one beneath the other, assuming that one teletext page comprises I teletext rows, is configured so that it can store video information on 2·1·n image lines.

In another embodiment of the method according to the invention, besides two first and second teletext pages TTX1, TTX2 presented one above the other, precisely one third teletext page TTX3 is represented horizontally in the picture next to the first and second teletext page TTX1, TTX2.

For this, the characters being represented from the first and second teletext page TTX1, TTX2 are selected from the first character set, which contains characters with m×n pixels, and the characters being represented for the third image are selected from a second character set, which contains characters with i×j pixels, where preferably m=i and j=2·n.

FIG. 4b shows, as an example, the pixel matrix of the teletext character “A” of the second character set, which contains 12×20 pixels, whereby in the example shown the character of the second character set represented in FIG. 4b is obtained from the character of the first character set represented in FIG. 4a, in that the pixel information of one line of the character in FIG. 4a is represented in two consecutive lines of the character in FIG. 4b, so that a doubling of the number of pixel lines results for the character of the second character set as compared to the number of pixel lines for the character of the first character set. In order to represent this character in an image built up line by line, first lines of the pixel matrix, such as even-numbered lines, are represented in even-numbered lines of the image, and second lines of the pixel matrix, such as odd-numbered lines, are represented in odd-numbered lines of the image.

FIG. 6a shows the representation of the character according to FIG. 4b of the second character set by means of an image segment, when representing a line-interlaced sequence of fields on the display device, where HB1 is the field corresponding to FIG. 5a, in which video information is represented in the even-numbered lines, and where HB2 is the field in which video information is represented in the odd-numbered lines.

FIG. 6b shows, accordingly, the character according to FIG. 4b when representing a sequence of frames on the display device.

To implement this method, a memory is required corresponding to the memory for representation of an image in FIG. 10. For the representation of the third teletext page, because of the characters used from the second character set, one will require twice as many image lines as for the representation of the first or second teletext page. Assuming that one teletext line consists of k rows, I columns, a memory will be required to save 2·k·m×2·1·n pixel information, while one memory line of the memory containing 2·k·m pixel information will be read out during a time when one line of the picture being represented is written.

FIG. 7 shows schematically a teletext processing device to implement the method according to the invention, wherein the device receives a teletext signal TTS separated from an FBAS signal. The device comprises a decoding unit 21, to which a page memory 22 is connected, in which the teletext information contained in the teletext signal TTS can be stored page by page, and the individual characters of a teletext page are saved in the memory in binary encoded form, for example. The decoding unit 21 can receive a page select signal SNo, which determines the teletext page saved in the memory 22 that is to be represented on the display device 16. Furthermore, the decoding unit 21 can receive a position signal POS, which indicates how many teletext pages are to be represented on one image of the display device 16 and in which positions these individual teletext pages should be placed. Thanks to this position signal POS, for example, one can decide to represent two teletext pages one above the other in the vertical direction in an image of the display device 16. The decoding unit 21 is coordinated with a memory 23, 24, which in the exemplary embodiment is formed from two memory blocks 23, 24, each of these memory blocks 23, 24 holding one of the two different character sets, which contain either characters with m×n or characters with i×j pixels.

The decoding unit 21 is configured so that, depending on the page select signal Sno, which can also determine the page numbers of several teletext pages being represented, so that it reads out the data of the particular teletext pages from the memory 22, assigns to the encoded teletext data read out either characters of the first character set from the first memory block or characters of the second character set from the second memory block 24, and stores the resulting matrix with pixel information in the memory unit 14 connected to the decoding unit 21. If the position signal POS indicates that two teletext pages are to be represented one above the other, as is shown for example in FIG. 8, the decoding unit 21 will read out the encoded data of these teletext pages from the page memory 22 and assign to the individual data the characters of the first character set from the first memory block 23 and load the resulting pixel information into the memory 14. This memory 14 will be read out by a unit 15 controlling the display device 16 in order to represent the pixel information on the monitor screen 16 and is organized, for example, line by line, as explained above. The memory 14 is preferably dynamically expandable so that, depending on the image being presented, it can save k·m×2·1·n pixel information to represent an image according to FIG. 8 or 2·k·m×2·1·n pixel information to represent images according to FIG. 9 or 10.

List of Reference Numbers

10 separation unit
11 decoding unit
12 page memory
13 character memory
14 memory unit
15 control unit
16 display device
21 decoding unit
22 page memory
23, 24 character memory
FBAS video signal
POS position signal
Sno page number
TTS teletext signal
TTX1-TTX3 teletext pages

1. Method for representation of teletext information of a first and a second teletext page one above the other in the vertical direction in an image of a display device constructed pixel by pixel, wherein the method comprises the following steps:
furnishing a teletext signal (TTS), comprising a sequence of encoded teletext characters,
furnishing a first character set with a number of characters, each of which is constructed from a matrix with m×n pixels,
selecting a character from the first character set assigned to each encoded teletext character,
representing the selected characters pixel by pixel on the display device (16), wherein pixel information from first lines of the pixel matrix of the character are represented in the even-numbered lines of the image when representing a character on the display device and pixel information from second lines of the pixel matrix of the character are represented in the odd-numbered lines of the image.

2. Method according to claim 1, comprising the following steps for the representation of teletext information of a third teletext page next to the first and second teletext page in the horizontal direction of the image:
furnishing a second character set with a number of characters, each constructed from a matrix of i×j pixels,
selecting a character of the third teletext page from the second character set, associated with each encoded teletext character,
wherein for the representation of a character of the third teletext page on the display device, pixel information from first lines of the pixel matrix of the character is represented in the even-numbered lines of the image and pixel information from second lines of the pixel matrix of the character is represented in the odd-numbered lines of the image.

3. Method according to claim 1, in which the first and second lines of the pixel matrix of the character are arranged in alternation.

4. Method according to one of claims 1, in which m=i and n=2·j.

5. Method according to claim 4, in which m=i=12 and j=10.
